(19) United States
(12) Patent Application Publication
(10) Pub. No.: US 2018/0005169 A1
(43) Pub. Date: Jan. 4, 2018

(54) APPARATUS AND METHOD FOR PROVIDING UNMANNED DELIVERY VEHICLES WITH EXPRESSIONS

(71) Applicant: Wal-Mart Stores, Inc., Bentonville, AR (US)

(72) Inventors: Donald R. High, Noel, MO (US); Noah Ryan Kapner, Noel, MO (US)

(21) Appl. No.: 15/638,960

(22) Filed: Jun. 30, 2017

Related U.S. Application Data
(60) Provisional application No. 62/357,688, filed on Jul. 1, 2016.

(51) Int. Cl. G06Q 10/08; G05D 1/00; B60Q 1/50; G06Q 10/06; G05D 1/02

(52) U.S. Cl. CPC G06Q 10/083; G06Q 10/06315; G05D 1/0274; B60Q 1/50; G05D 1/0011; G05D 1/0088

(57) ABSTRACT

Systems, apparatuses, and methods are provided herein for an unmanned delivery vehicle system. A delivery vehicle system comprises a locomotion system of an unmanned ground vehicle configured to transport items to customer locations for deliveries, a context sensor configured to collect data of a surrounding of the unmanned ground vehicle, an indicator system on an exterior of the unmanned ground vehicle, and a control circuit. The control circuit is configured to retrieve a task profile for a delivery trip, determine a context based on data from the context sensor during the delivery trip, select an expression based on the task profile and the context, and cause the indicator system to convey the expression.

### CROSS-REFERENCE TO RELATED APPLICATION

This application claims the benefit of the following U.S. Provisional Application No. 62/357,688 filed Jul. 1, 2016, which is incorporated herein by reference in its entirety.

### TECHNICAL FIELD

This invention relates generally to unmanned vehicles.

### BACKGROUND

An unmanned vehicle or uncrewed vehicle generally refers to a vehicle configured to travel without a person on board. Unmanned vehicles may be remote controlled or remote guided vehicles and/or may be autonomous vehicles capable of navigating by sensing their environment.

### BRIEF DESCRIPTION OF THE DRAWINGS

Disclosed herein are embodiments of apparatuses and methods for operating an unmanned delivery vehicle. This description includes drawings, wherein:

FIG. 1 is a block diagram of a system in accordance with several embodiments.

FIG. 2 is a flow diagram of a method in accordance with several embodiments.

FIG. 3 is an illustration of an unmanned delivery vehicle in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for operating an unmanned ground vehicle. A delivery vehicle system comprises a locomotion system of an unmanned ground vehicle configured to transport items to customer locations for deliveries, a context sensor configured to collect data of a surrounding of the unmanned ground vehicle, an indicator system on an exterior of the unmanned ground vehicle, and a control circuit. The control circuit being configured to: retrieve a task profile for a delivery trip, determine a context based on data from the context sensor during the delivery trip, select an expression based on the task profile and the context, and cause the indicator system to convey the expression.

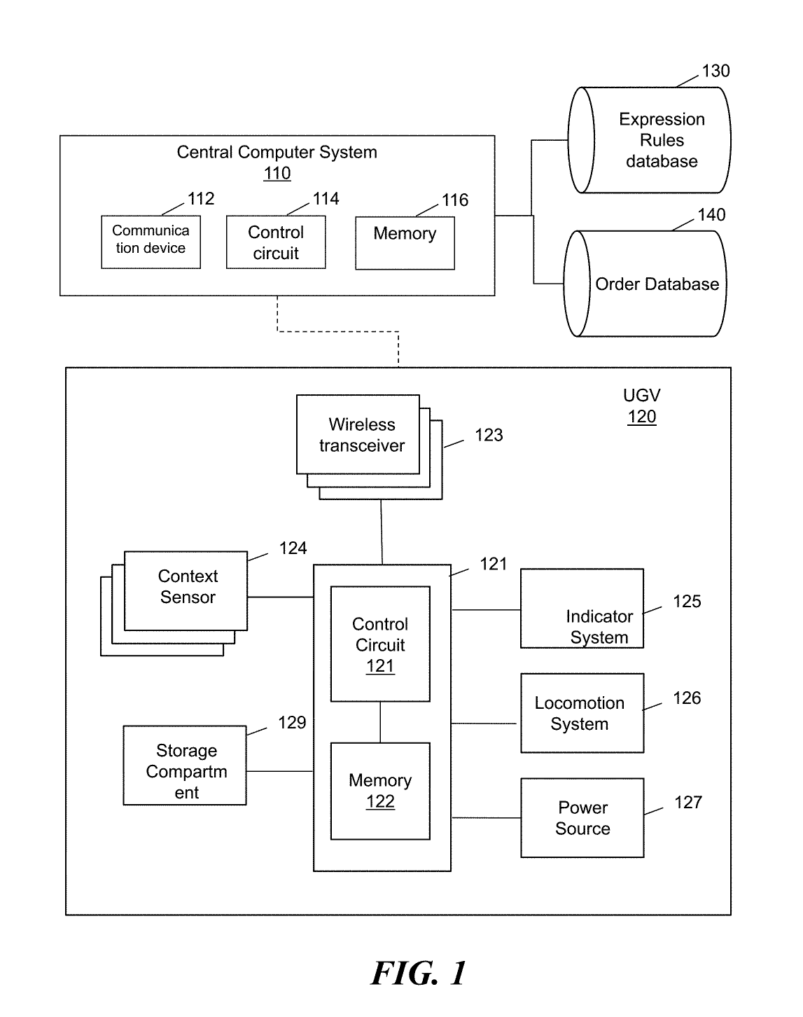

Referring now to FIG. 1, a system for providing a delivery vehicle with expressions is shown. The system comprises an unmanned ground vehicle (UGV) 120, a central computer system 110, an expression rules database 130, and an order database 140.

In some embodiments, a UGV 120 may comprise one or more of a self-driving vehicle, a wheeled robot, an unmanned movable delivery unit, an autonomous ground vehicle (AGV), a semi-autonomous ground vehicle, and the like. Generally, the UGV 120 may comprise any device configured to travel and transport items to a destination while unmanned. The UGV 120 may be configured to transport one or more items to a delivery location such as a customer residence, customer office, customer current location, etc. In some embodiments, the UGV may comprise an autonomous or semi-autonomous vehicle configured to travel on the automobile roadway and/or other paths such as sidewalks and bike lanes. In some embodiments, the UGV 120 may comprise a housing enclosing and/or coupled to one or of more of a control unit 121 comprising a control circuit 122 and a memory 123, a context sensor 124, an indicator system 125, a locomotion system 126, a power source 127, a wireless transceiver 128, and a storage compartment 129.

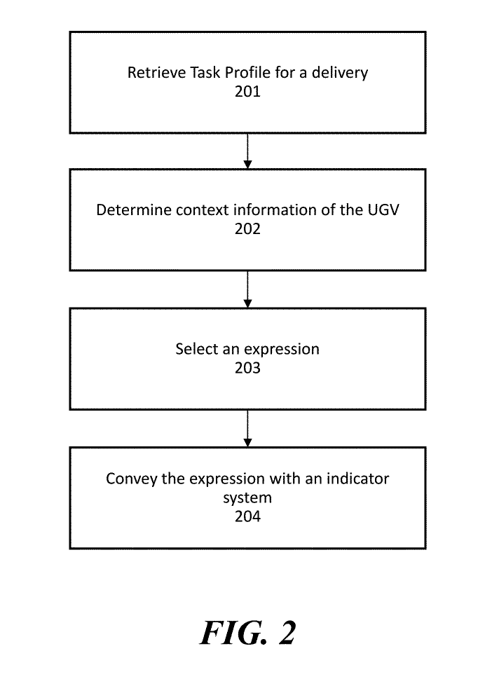

The control circuit 122 may comprise a central processing unit, a processor, a microprocessor, and the like. The control circuit 122 may be configured to execute computer readable instructions stored on the computer readable storage memory 123. The computer readable storage memory 123 may comprise volatile and/or non-volatile memory and have stored upon it a set of computer readable instructions which, when executed by the control circuit 122, causes the control circuit 122 to operate the indicator system 125 based on the data collected by the context sensor 124 and/or information received from the central computer system 110. In some embodiments, the control unit 121 may comprise the navigation controller of the UGV 120 configured to drive and steer the UGV 120 based on delivery instructions received from the central computer system 110. In some embodiments, the computer executable instructions may cause the control circuit 122 of the UGV 120 to perform one or more steps in the methods and processes described with reference to FIG. 2 herein. In some embodiments, the memory 123 may further store task profiles and/or received from the central computer system 110 and/or expression profiles such as light and sound patterns, videos, graphics, text, audio, etc. configured to be expressed with indicator system 125. In some embodiments, at least some expression profiles may be preloaded onto the memory 123 prior to a delivery trip. In some embodiments, expressions may be streamed and/or downloaded from the central computer system 110 to the UGV 120 during a delivery trip. In some embodiments, the memory 123 may further store one or more trigger conditions associated with the expressions.

The context sensor 124 may comprise one or more types of sensor devices for gathering data from the surrounding of the UGV 120 to determine context information of the UGV 120. In some embodiments, the context sensor 124 may comprise one or more of a location sensor, a range sensor, an image sensor, a sound sensor, a light sensor, a weather sensor, and a data receiver. In some embodiments, the context sensor 124 may be configured to collect information relating to characteristics of one or more of location, weather, detected persons, detected animals, detected objects, and neighborhood demographics. In some embodiments, the context sensor 124 may comprise at least some of navigation sensors of the navigation system of the UGV 120 such as a GPS sensor, a proximity sensor, an obstacle detector, and the like. In some embodiments, the context sensor 124 may provide data for determining the location of the UGV 120 and the location information may be used to retrieve one or more of an area demographic information, an area environmental condition, an area building information to use as context information. In some embodiments, the context sensor 124 may communicate with one or more of a user device a wireless router, and a mobile data tower to collect context information.

The indicator system 125 may comprise one or more indicator devices configured to convey expressions to persons in the proximity of the UGV 120. In some embodiments, the indicator system 125 may comprise one or more of a light system, a color changing light system, a speaker, a display screen, a hydraulics system, a motored movable part, and the like. In some embodiments, the indicator system 125 may comprise one or more output only devices. In some embodiments, the indicator system 125 may comprise a plurality of light sources configured to produce a light pattern visible from the exterior of the UGV 120. In some embodiments, the indicator system 125 may comprise one or more color changing light emitting diodes (LEDs) positioned at one or more locations on the exterior of the UGV 120. In some embodiments, the indicator system 125 may comprise the navigation illumination lights (e.g. headlights) of the UGV 120. In some embodiments, the indicator system 125 may comprise a hydraulics system for moving and/or lifting at least a portion of the UGV 120. In some embodiments, the hydraulics system may comprise the hydraulics system of the locomotion system 126 configured to allow the UGV 120 travel on uneven terrains. In some embodiments, the hydraulics system may cause the body of the UGV 120 to move up and down and/or side to side to simulate a dancing motion.

In some embodiments, the UGV 120 may further comprise one or more user input devices such as a touchscreen, a microphone, and one or more buttons. In some embodiments, the UGV 120 may be configured to interact with users during a delivery trip via the user input devices. For example, a user may inquiry the UGV 120 and receive a response. In some embodiments, the response of the inquiry may be selected based on the assigned task profile and/or context of the UGV 120. For example, the same inquiry (e.g. “where are you going?”) may generate different responses (e.g. “going home” or “visiting a good friend”) based on the task and/or context of the UGV 120. In some embodiments, the UGV 120 may be configured to briefly stop on the delivery route while a user interacts with it.

The locomotion system 126 may be operated by the control circuit 122 to permit the UGV 120 to travel to and from delivery locations to perform deliveries. In some embodiments, the locomotion system 126 may include at least one powered wheel for moving the UGV 120 through one or more of streets, roadways, sidewalks, driveways, etc. The locomotion system 126 may include any number of rotating wheels and/or other floor-contacting mechanisms as may be desired and/or appropriate to the application setting. For example, the locomotion system 126 may be configured to travel on one or more of a pave motor vehicle roadway, a sidewalk, a bike lane, a gravel road, a dirt path, and the like.

The power source 127 may be coupled to one or more of the other components of the UGV 120 to provide power for the operation of the UGV 120. In some embodiments, the power 127 may comprise as one or more of a rechargeable battery, a replaceable battery, a fuel cell, a solar panel, and a power grid connection. The power provided by the power source 127 may be used to power one or more of the control unit 121, the indicator system 125, the locomotion system 126, the context sensor 124, the storage compartment 129, and the wireless transceiver 128 of the UGV 120. In some embodiments, a second power source may be provided to power the locomotion system 126 separate from the power source of the electrical components of the UGV 120. In some embodiments, the UGV 120 may include a plug or other electrically conductive interface for connecting with to an external source of electrical energy to recharge the power source 127.

The wireless transceiver 128 may comprise a wireless communication device configured to allow the control circuit 122 to communicate with a remote system such as the central computer system 110 over a network such as a mobile network, a wireless network, a secured network, a private network, and the Internet. In some embodiments, the wireless transceiver 128 may comprise one or more of Wi-Fi transceiver, a mobile data network transceiver, a cellular network transceiver, a satellite network transceiver, and the like.

The storage compartment 129 may comprise one or more compartments for holding one or more items for delivery. In some embodiments, the storage compartment 129 may comprise one or more storage spaces and one or more access doors. In some embodiments, the control circuit 122 may control the access to the storage spaces through the access doors. For example, at the delivery destination, the control circuit 122 may authenticate a recipient prior to releasing an access door locking mechanism to allow access to the content of the storage compartment 129. In some embodiments, the storage compartment 129 may comprise a plurality of compartments assigned to different recipients. The control circuit 122 may selectively allow access to one or more compartments based on the identity of the authenticated recipient. In some embodiments, the storage compartment 129 may comprise a cooling and/or heating element for regulating the temperature inside of the storage space.

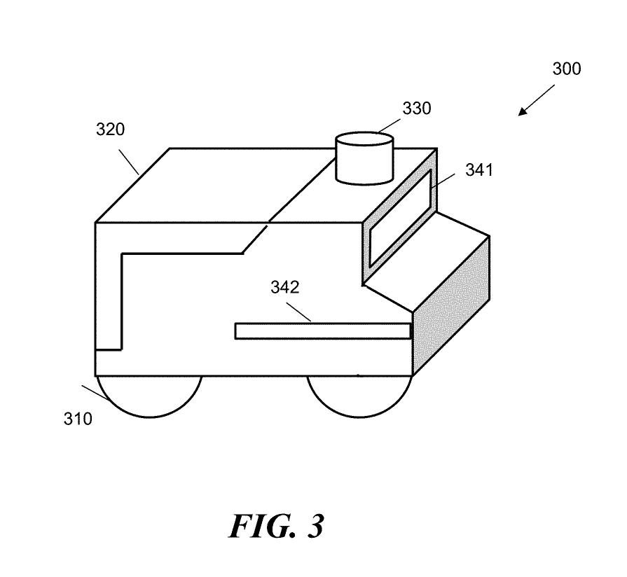

The central computer system 110 comprises a control circuit 114, a memory 116, and a communication device 112. The central computer system 110 may comprise one or more of a server, a central computing system, a delivery management computer system, and the like. In some embodiments, the central computer system 110 may comprise a system of two or more processor-based devices. The control circuit 114 may comprise a processor, a microprocessor, and the like and may be configured to execute computer readable instructions stored on a computer readable storage memory 116. The computer readable storage memory 116 may comprise volatile and/or non-volatile memory and have stored upon it, a set of computer readable instructions which, when executed by the control circuit 114, causes the central computer system 110 to provide delivery instructions and/or a task profile to the UGV 120. In some embodiments, the control circuit 114 may further instruct the UGV 120 to travel to one or more delivery locations while conveying expressions via the indicator system 125 based on a task profile and the context of the UGV 120. In some embodiments, the central computer system 110 may further be configured to determine a task profile for a delivery trip to be performed by the UGV 120. In some embodiments, the computer executable instructions may cause the control circuit 114 of the central computer system 110 to perform one or more steps in the methods and processes described with reference to FIGS. 2-3 herein.

The communication device 112 of the central computer system 110 may comprise a network interface configured to communicate with one or more UGVs via a network such as the Internet, a private network, a secure network, and the like. In some embodiments, the communication device 112 may comprise a network adapter, a modem, a router, a wireless transceiver, and the like.

The central computer system 110 may be coupled to an expression rules database 130 and/or an order database 140 via wired and/or wireless communication channels. In some embodiments, one or more of the expression rules database 130 and the order database 140 may be at least partially implemented with the memory 116 of the central computer system 110 and/or the memory 123 of the UGV 120. In some embodiments, the one or more of the expression rules database 130 and the order database 140 may be directly accessible by the UGV 120 separate from the central computer system 110.

The expression rules database 130 may have stored upon it a plurality expressions that may be conveyed with the indicator system 125 of the UGV 120 and trigger conditions associated with the expressions. Expressions of the UGV 120 may comprise one or more of light color, light pattern, audio, music, sound pattern, machine synthesized speech, image, video, and movement pattern. In some embodiments, the sounds provided by UGV 120 may comprise verbal and/or non-verbal audio. In some embodiments, trigger conditions of expressions may comprise conditions relating to the UGV's task profile and/or context. A task profile may comprise one or more of route neighborhood profile, recipient profile, delivery content information, delivery trip date, delivery trip purpose, special delivery message, and the like. In some embodiments, a task profile may comprise information relating to the delivery and/or the delivery route that the system can determine prior to a delivery trip. The context of a UGV may comprise characteristics relating to one or more of location, weather, detected persons, detected animals, detected objects, neighborhood demographics, and the like. In some embodiments, the context of the UGV may comprise information derived at least in part based on data detected by one or more sensors such as the context sensor 124 on the UGV 120. In some embodiments, an expression may be triggered when one or more items of the task profile and context information match the trigger condition associated with the expression. For example, a UGV 120 may be configured to produce a red and blue light pattern for a delivery trip performed near Fourth of July and when the presence of a child is detected. In another example, a UGV may be configured to play upbeat notes on a sunny day while passing by a park on the delivery route.

In some embodiments, an expression may be further selected based on a personality and/or a language profile selected based on at least one of the task profile and the context. For example, the task profile may specify the predominate language in each neighborhood on a planned delivery route assigned to a UGV 120. The UGV 120 may be configured to convey greetings in different languages based on the task profile. In another example, a UGV 120 may be assigned a “professional” personality when passing through an office park area during business hours and a “friendly” personality when passing through a residential neighborhood. The personality profiles may then effect which expression is selected to be conveyed by the UGV 120. In some embodiments, a personality profile may be selected based on the task profile and an expression may be selected from expressions associated with the personality profile based on the context of the UGV 120. In some embodiments, expressions may further comprise alarms triggered by warning condition. For example, if a UGV 120 detects that it is touched, shaken, and pushed during a delivery trip, the indicator system 125 may be configured to generate an alarm sound or alarm light pattern. In some embodiments, warning conditions and at least some of the expression rules may be stored locally in the memory 123 of the UGV 120. In some embodiments, the expression rules database 130 may comprise specialized database structure for associating UGV expressions with trigger conditions comprising one or more of a task profile items and context information items.

The order database 140 may be configured to store one or more orders to be delivered by UGVs. The central computer system 110 may use the information in the order database 140 to configure task profiles of one or more UGVs 120. For example, the system may determine one or more of a delivery route, route neighborhood profile, recipient profile, delivery content information, delivery trip date, delivery trip purpose, and special delivery message based on the order(s) assigned to the UGV 120 and stored in the order database 140. In some embodiments, the central computer system 110 may further be configured to manage the receiving and/or fulfillment of the one or more orders in the order database 140. In some embodiments, the expression rules database 130 may comprise specialized database structure for associating orders to be fulfilled by UGV with order information such as ordered items, customer profile, delivery destination, delivery date, delivery instructions, delivery message, etc.

While one UGV is shown in FIG. 1, the central computer system 110 may be configured to simultaneously communicate with a plurality of UGVs in the system. In some embodiments, the UGV 120 may be configured to perform at least part of the delivery trip and convey one or more expressions without maintaining data connectivity with the central computer system 110. For example, a task profile and one or more expression rules may be pre-loaded into the memory 123 of the UGV 120 and control circuit 122 may select an expression without communicating with the central computer system 110. In some embodiments, only expressions rules relevant to the task profile and/or personality profile assigned to the UGV 120 may be selected loaded onto the UGV 120. In some embodiments, the UGV 120 may relay context information collected by the context sensor 124 back to the central computer system 110. The central computer system 110 may then determine an expression to be conveyed by the UGV 120.

Referring now to FIG. 2, a method for operating a UGV is shown. Generally, the method shown in FIG. 2 may be implemented with a processor-based device such as a control circuit, a central processor, and the like. In some embodiments, the method shown in FIG. 2 may be implemented with the control circuit 122 of the UGV 120 and/or a processor-based server device such as the central computer system 110 described with reference to FIG. 1 herein.

In some embodiments, prior to step 201, the system assigns a delivery trip to a UGV and prepares the UGV for delivery and loads items to be delivered into the storage compartment(s) of the UGV. In some embodiments, the system further determines a route for the delivery trip and/or configures a task profile for the UGV based on the order and/or route information associated with the delivery trip.

In step 201, the system retrieves a task profile for a delivery trip to be carried out by a UGV. In some embodiments, the UGV may comprise the UGV 120 described with reference to FIG. 1 herein and/or other similar devices. In some embodiments, the task profile may comprise one or more of route neighborhood profile, recipient profile, delivery content information, delivery trip date, delivery trip purpose, and special delivery message. In some embodiments, a task profile may comprise information relating to the delivery and/or the delivery route that the system can determine prior to a delivery trip. In some embodiments, the task profile may be configured based at least in part on orders to be fulfilled via the UGV. In some embodiments, the task profile and/or one or more related expressions may be downloaded to a memory device on the UGV in step 201.

In step 202, the system determines a context of the UGV during the delivery trip. In some embodiments, the context of the UGV may be determined based on data from a context sensor on the UGV. In some embodiments, the context sensor may comprise one or more sensor devices for gathering data to determine context information of the UGV such as the context sensor 124 described with reference to FIG. 1 herein. In some embodiments, the context information may be determined based on one or more of a location sensor, a range sensor, an image sensor, a sound sensor, a light sensor, a weather sensor, and a data receiver. In some embodiments, the context sensor may be configured to collect information relating to characteristics of one or more of location, weather, detected persons, detected animals, detected objects, and neighborhood demographics as context information.

In step 203, the system selects an expression based on the task profile from step 201 and the context determined in step 202. In some embodiments, step 203 may be performed locally at the UGV. The UGV may perform step 203 based on information stored on the UGV's memory device and/or information retrieved from a remote server. In some embodiments, the context information detected by sensors on the UGV may be relayed to a remote server, and step 203 may be at least partially performed by the remote server. The selection of the expression may then be communicated back to the UGV to perform.

In some embodiments, the expression may be selected by matching the one or more items in the task profile and the context information with trigger conditions associated with a plurality of expressions specified in an expression rules database. For example, a UGV may be configured to produce a red and blue light pattern for a delivery trip performed near Fourth of July and when the presence of a child is detected. In another example, a UGV may be configured to play upbeat notes on a sunny day while passing by a park on the delivery route. In some embodiments, the expression may be further selected based on a personality and/or a language profile selected based on at least one of the task profile and the context. For example, the task profile may specify the predominate language in each neighborhood on the planned route of a UGV. The UGV may be configured to convey greetings in different languages based on the task profile and the UGV's current location. In another example, a UGV may be assigned a “professional” personality when passing through an office park area during business hours and a “friendly” personality when passing through a residential neighborhood. The personality profiles may then effect which expression is selected to be conveyed by the UGV (e.g. “good afternoon” or “hey there!”). In some embodiments, expressions may comprise same words spoken with different voices, tones, inflections, and/or cadences. In some embodiments, the expressions may further comprise alarms triggered by warning conditions. For example, if a UGV detects that it is touched, shaken, and pushed during a delivery trip, the indicator system may be configured to generate an alarm sound or alarm light pattern. In some embodiments, warning conditions and at least some of the expression rules may be stored locally in the memory of the UGV. In some embodiments, an expression may comprise an order specific message. For example, a UGV may be configured to deliver a special message when an item is retrieved by a recipient (e.g. sing the “happy birthday” song).

In step 204, the system causes the expression selected in step 203 to be conveyed with an indicator system of the UGV. An indicator system may comprise one or more indicator devices configured to convey expressions to persons in the proximity of the UGV. In some embodiments, an indicator system may comprise one or more of a light system, a color changing light system, a speaker, a display screen, a hydraulics system, a motored movable part, and the like. In some embodiments, the indicator system 125 may comprise a plurality of light sources configured to produce a light pattern visible from the exterior of the UGV. In some embodiments, the indicator system may comprise a hydraulics system for moving and/or lifting at least a portion of the UGV to simulate motion (e.g. nod, dance). In some embodiments, the indicator system may comprise the indicator system 125 described with reference to FIG. 1 or a similar system.

In some embodiments, the system may repeat steps 202-204 throughout a delivery trip. In some embodiments, the system may wait for an expression (e.g. a light sequence, a sound sequence) to complete prior commencing the next expression selected for the UGV.

Next referring to FIG. 3, an illustration of an unmanned ground vehicle (UGV) 300 is shown. In some embodiments, the UGV 300 may comprise the UGV 120 described with reference to FIG. 1 herein or a similar system. The UGV 300 shown in FIG. 3 comprises a sensor system 330, a storage compartment 320, a set of wheels 310, and an indicator system comprising lights 341 and 342.

The wheels 310 may be configured to drive and steer the UGV 300 on the ground. While two wheels are shown, a UGV may generally include any number of wheels and/or other locomotion devices without departing from the spirit of the present invention. In some embodiments, the wheels 310 may comprise the locomotion system 126 described with reference to FIG. 1 herein or a similar system.

The storage compartment 320 may be configured to lock and/or open to control access to the content of the UGV 300. While one access door to the storage compartment 320 is shown, one or more accesses doors to different compartments may be provided on a UGV 300. In some embodiments, the storage compartment 320 may comprise the storage compartment 129 described with reference to FIG. 1 herein or a similar device.

The sensor system 330 may comprise context and/or navigation sensors. In some embodiments, the sensor system 330 may comprise the context sensor 124 described with reference to FIG. 1 herein or similar devices. While a rooftop sensor assembly is shown in FIG. 3, in some embodiments, one or more sensors may be positioned on other parts of the UGV 300. For example, a proximity sensor may be positioned around the perimeter of the UGV. Sensors may also be located at multiple locations on the UGV 300.

Lights 341 and 342 may comprise the indicator system of the UGV 300. In some embodiments, lights 341 and 342 may each comprise one or more light sources such as light-emitting diode (LED) and color changing light bulbs. The lights 341 and 342 may be configured to generate an on/off and/or color pattern as controlled by the control circuit of the UGV 300 to convey an expression of the UGV 300. In some embodiments, the indicator system of the UGV 300 may additionally or alternatively comprise other devices such as a speaker, a display screen, a hydraulics system, and a motored movable part. Additionally, the placement of the lights 341 and 342 are provided as examples only. Lights may be placed on any portion of to function as indicators without departing from the spirit of the present disclosure. In some embodiments, one or more of the lights 341 and 342 may also function as visibility illuminations (e.g. headlights) for the UGV's navigation system.

In FIG. 3, the size, shape, and configuration of the UGV 300 are provided as an example only. A UGV configured to transport items for deliveries may generally be of various size, shape, and configuration without departing from the spirit of the present disclosure.

UGVs are sometimes difficult to see and the navigation of a UGV at times require night visibility. A UGV that is noticeable and conveys a personality may reduce the likelihood that people will interfere with the UGV operations. In some embodiments, light and sound may be added to UGVs to convey greetings to help people feel more comfortable with the UGVs. The lights and sound may additionally provide security and simulate a personality based on the activity/task assigned to the UGV.

In some embodiments, a UGV may include lights and sound which match the situation, mood, and voice inflections of the situation as the UGV communicate with people. The UGV may be equipped with sensors for detecting the situation and controls a lights and sound module to react accordingly. In some embodiments, the UGV may determine a personality to convey locally and/or via a remote central server and determine lights and sound behavior based on the determined personality. In some embodiments, the UGV may interact with humans by adjusting and lights and sound accordingly to the type, age, language, culture, and/or events associated with the humans.

In one embodiment, a delivery vehicle system comprises a locomotion system of an unmanned ground vehicle configured to transport items to customer locations for deliveries, a context sensor configured to collect data of a surrounding of the unmanned ground vehicle, an indicator system on an exterior of the unmanned ground vehicle, and a control circuit. The control circuit being configured to: retrieve a task profile for a delivery trip, determine a context based on data from the context sensor during the delivery trip, select an expression based on the task profile and the context, and cause the indicator system to convey the expression.

In one embodiment, a method for operating a delivery vehicle system, comprises retrieving, at a control circuit on an unmanned ground vehicle, a task profile for a delivery trip to be performed by an unmanned locomotion system configured to transport items to customer locations for deliveries, determining a context of based on a context sensor during the delivery trip, the context sensor being configured to collect data of a surrounding of the unmanned ground vehicle, select, with the control circuit, an expression based on the task profile and the context, and cause an indicator system on an exterior of the unmanned ground vehicle to convey the expression.

In one embodiment, an apparatus for operating a delivery vehicle comprises a non-transitory storage medium storing a set of computer readable instructions, and a control circuit configured to execute the set of computer readable instructions which causes to the control circuit to: determine a task profile for an unmanned ground vehicle configured to transport items to customer locations for deliveries, determine a context of the unmanned ground vehicle based on data from a context sensor on the unmanned ground delivery vehicle, select an expression based on the task profile and the context, and cause an indicator system on the unmanned ground delivery vehicle to convey the expression.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An unmanned delivery vehicle system for delivering products to customers comprising:
a locomotion system of an unmanned ground vehicle configured to transport items to customer locations for deliveries;
a context sensor configured to collect data of a surrounding of the unmanned ground vehicle, the context sensor comprises a location sensor, an image sensor, and a sound sensor;
an indicator system on an exterior of the unmanned ground vehicle comprising a speaker and indicator lights; and
a control circuit coupled to the locomotion system, the context sensor, and the indicator system, the control circuit being configured to:
retrieve a task profile for a delivery trip the task profile comprises one or more route neighborhood profiles;
determine a context based on data from the context sensor during the delivery trip;
select a personality profile from a plurality of personality profiles based on a route neighborhood profile in the task profile associated with a current location of the unmanned ground vehicle;
detect, via the context sensor, a trigger condition of an expression associated with the personality profile; and
cause the speaker and the indicator lights of the indicator system to convey the expression.

2. The system of claim 1, wherein the context sensor further comprises one or more of a range sensor, a light sensor, a weather sensor, and a data receiver.

3. The system of claim 1, wherein the indicator system further comprises one or more of a light system, a color changing light system, a display screen, a hydraulics system, and a motored movable part.

4. The system of claim 1, wherein the task profile further comprises one or more of recipient profile, delivery content information, delivery trip date, delivery trip purpose, and special delivery message.

5. The system of claim 1, wherein the context comprises characteristics relating to one or more of location, weather, detected persons, detected animals, detected objects, and neighborhood demographics.

6. The system of claim 1, wherein the expression comprises one or more of light color, light pattern, audio, music, sound pattern, machine synthesized speech, image, video, and movement pattern.

7. The system of claim 1, wherein the expression is further selected based on a language profile selected based on at least one of the task profile and the context.

8. The system of claim 1, wherein the control circuit is further configured to:
receive an inquiry from a person during the delivery trip;
determine a response to the inquiry based on at least one of the task profile and the context; and
cause the indicator system to provide the response to the person.

9. The system of claim 1, wherein the control circuit is further configured to:
detect a warning condition; and
cause the indicator system to generate an alarm.

10. The system of claim 1, wherein at least one of the task profile and the expression is retrieved from a central computer system communicating with the unmanned ground vehicle via a wireless transceiver.

11. A method for operating a delivery vehicle system for delivering products to customers, comprising:
retrieving, at a control circuit on an unmanned ground vehicle, a task profile for a delivery trip to be performed by an unmanned locomotion system configured to transport items to customer locations for deliveries, the task profile comprises one or more route neighborhood profiles;
determining a context of based on a context sensor during the delivery trip, the context sensor being configured to collect data of a surrounding of the unmanned ground vehicle and comprises a location sensor, an image sensor, and a sound sensor;
selecting, with the control circuit, a personality profile from a plurality of personality profiles based on a route neighborhood profile in the task profile associated with a current location of the unmanned ground vehicle;
detecting, via the context sensor, a trigger condition of an expression associated with the personality profile; and
causing an indicator system on an exterior of the unmanned ground vehicle to convey the expression, the indicator system comprises a speaker and indicator lights.

12. The method of claim 11, wherein the context sensor further comprises one or more of a range sensor, a light sensor, a weather sensor, and a data receiver.

13. The method of claim 11, wherein the indicator system comprises one or more of a light system, a color changing light system, a display screen, a hydraulics system, and a motored movable part.

14. The method of claim 11, wherein the task profile further comprises one or more of route neighborhood profile, recipient profile, delivery content information, delivery trip date, delivery trip purpose, and special delivery message.

15. The method of claim 11, wherein the context comprises characteristics relating to one or more of location, weather, detected persons, detected animals, detected objects, and neighborhood demographics.

16. The method of claim 11, wherein the expression comprises one or more of light color, light pattern, audio, music, sound pattern, machine synthesized speech, image, video, and movement pattern.

17. The method of claim 11, wherein the expression is further selected based a language profile selected based on at least one of the task profile and the context.

18. The method of claim 11, further comprising:
receiving an inquiry from a person during the delivery trip;
determining a response to the inquiry based on at least one of the task profile and the context; and
causing the indicator system to provide the response to the person.

19. The method of claim 11, further comprising:
detecting a warning condition; and
causing the indicator system to generate an alarm.

20. The method of claim 11, wherein at least one of the task profile and the expression is retrieved from a central computer system communicating with the unmanned ground vehicle via a wireless transceiver.

21. An apparatus for operating a delivery vehicle comprising:
a non-transitory storage medium storing a set of computer readable instructions; and
a control circuit configured to execute the set of computer readable instructions which cause to the control circuit to:
determine a task profile for an unmanned ground vehicle configured to transport items to customer locations for deliveries, the task profile comprises one or more route neighborhood profiles;
determine a context of the unmanned ground vehicle based on data from a context sensor on the unmanned ground vehicle, the context sensor comprises a location sensor, an image sensor, and a sound sensor;
select a personality profile from a plurality of personality profiles based on a route neighborhood profile in the task profile associated with a current location of the unmanned ground vehicle;
detecting, via the context sensor, a trigger condition of an expression associated with the personality profile; and
cause an indicator system on the unmanned ground vehicle to convey the expression, the indicator system comprises a speaker and indicator lights.
